(19) United States
(12) Patent Application Publication
(10) Pub. No.: US 2026/0038787 A1
(43) Pub. Date: Feb. 5, 2026

(54) Precursor Suppression in Tandem Mass Spectrometry

(71) Applicant: DH Technologies Development Pte. Ltd., Singapore (SG)

(72) Inventors: Thomas BINKO, Toronto (CA); Nicholas G. BLOOMFIELD, Newmarket (CA); Martian DIMA, Richmond Hill (CA); Graham A. LEITH, Toronto (CA); Pavel RYUMIN, North York (CA)

(21) Appl. No.: 19/154,527

(22) PCT Filed: Feb. 7, 2024
(86) PCT No.: PCT/IB2024/051135

§ 371 Date: Aug. 7, 2025

Related U.S. Application Data
(60) Provisional application No. 63/444,748, filed on Feb. 10, 2023.

(51) Int. Cl. H01J 49/02; H01J 49/00; H01J 49/40

(52) U.S. Cl. CPC H01J 49/025; H01J 49/004; H01J 49/40

(57) ABSTRACT

In one aspect, a method of performing mass spectrometry is disclosed, which includes acquiring mass detection signals generated by an ion detector during an ion extraction event in a time-of-flight (ToF) mass analyzer in response to incidence of ions thereon, and applying an adjustable gain to the mass detection signals, wherein the step of applying the adjustable gain to the mass detection signals is performed dynamically based on m/z regions associated with said mass detection signals.

### RELATED APPLICATIONS

This application claims priority to U.S. Provisional Application No. 63/444,748 filed on Feb. 10, 2023, the contents of which are incorporated herein in their entirety.

### TECHNICAL FIELD

The present disclosure relates to mass spectrometry and more particularly to methods and systems for enhancing dynamic range of signal acquisition in mass spectrometry.

### BACKGROUND

The present teachings are generally directed to systems and methods for mass spectrometry, and more particularly, to the application of an adjustable dynamic gain to mass-to-charge signals generated by a time-of-flight (ToF) mass analyzer.

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur.

A spectrum dynamic range is an important characteristic of a mass spectrometer and is defined as the ratio of the lowest detectable mass signal to the highest detectable mass signal in a single spectrum. In a time-of-flight (ToF) mass analyzer, the lowest signal intensity that can be detected is limited by the noise level while the highest signal intensity that can be detected is often limited by the number of ions that can be concurrently detected in a single ion detection event. Further, the frequency of ToF extractions performed by a ToF mass analyzer is generally very high (e.g., greater than 10 kHz) compared to a typical ion accumulation time (e.g., in an ion trap) of about 10 ms. For example, in some such situations, each ToF spectrum may contain at least 100 ToF extractions with the upper limit of detection being correlated to a maximum number of ions the detection system can handle multiplied by the number of ToF extractions.

However, in certain cases, the number of ToF extractions containing mass signal is not equal to the total number of ToF extractions. In other words, in certain cases, not every ToF extraction includes a mass signal. In such cases, the multiplier associated with the number of ToF extractions corresponds to the number of ToF extractions containing mass signal(s). By way of example, such situations can occur when ions are trapped and released prior to the mass analysis in a ToF mass analyzer since the frequency of trap/release cycle is often much lower than the ToF analyzer speed. Such trap/release arrangements are particularly useful in MS/MS analysis, where an analyte can be interrogated via ion-ion, ion-particle and ion-radiation reactions, such as ultraviolet photo dissociation (UVPD), infrared multi photon dissociation (IRMPD), electron activated dissociation (EAD), electron transfer dissociation (ETD), and proton transfer reaction (PTR). In such cases, the effective number of ToF pulses will be mostly defined by the trap/release cycle frequency, which can in turn hamper the in-spectrum dynamic range. The necessity for prolonged reaction times can stem from typically inherently poor fragmentation/reaction efficiency in such fragmentation techniques. Consequently, in-spectrum dynamic range in such cases is often lower than in beam type collision induced dissociation techniques or cases where no fragmentation takes place, such as ToF MS acquisition.

Further, in certain fragmentation techniques, such as EAD, the total number of possible fragment ion types can be high. Further, in EAD, the interrogation of singly charged ions may lead to precursor and fragment neutralization reactions, which can lead to a high ratio of the remaining precursor ions relative to fragment ions under optimal reaction conditions. In case of multiply charged ions, in addition to product neutralization, secondary fragmentation may occur, which leads to uninformative internal fragment ions. Such discrepancy in precursor-to-fragment abundance can further exacerbate the difficulty for in-spectrum dynamic range adjustments since both the intense remaining precursor and low intensity fragment ions need to be co-detected.

Moreover, data acquisition under very high ion loads, which is preferable for facile detection of fragment ions with a low abundance, can lead to undesirable data artefacts.

### SUMMARY

In one aspect, a method of performing mass spectrometry is disclosed, which includes using an ion detector associated with a time-of-flight (ToF) mass analyzer to detect ions associated with at least one ToF ion extraction event, generating respective ion detection signals, and applying an adjustable gain to the ion detection signals thereby generating gain-adjusted ion detection signals, wherein the gain applied to each ion detection signal is selected as one of a baseline gain and a fraction of the baseline gain based on an expected intensity of the ion detection signal.

In some embodiments, the ToF ion extraction event includes one or more ion detection signals for which the baseline gain is selected and one or more ion detection signals for which a fraction of the baseline gain is selected.

In some embodiments, the method can further include digitizing the gain-adjusted ion detection signals so as to generate a plurality of digital gain-adjusted ion detection signals. The digital gain-adjusted ion detection signals can be processed to correct for variations, if any, in the gain applied to the ion detection signals. A mass spectrum of the corrected signals can then be constructed, e.g., using methods known in the art as informed by the present teachings. By way of example, the corrected digital gain-adjusted ion detection signals can be generated via application of a scaling factor to those signals. By way of example, the scaling factor for application to each ion detection signal can be a ratio of the baseline gain relative to the gain associated with that ion detection signal.

In some embodiments, a survey scan is performed, e.g., at a sufficiently low gain, to acquire data indicative of the expected intensities of the ion detection signals. The expected intensities can then be utilized to determine the gain required for application to each ion detection signal. For example, for ion detection signals having intensities that exceed a threshold, a fraction of the baseline gain can be employed as the gain applied to those ion detection signals. In some such cases, the fraction of the baseline gain can be selected from a set of pre-defined fractions, e.g., 20%, 40%, 60%, etc. By way of example, in some such embodiments, for ion signal intensities that are expected to be greater than a predefined threshold by a factor in a range of about 10 to about 5, the gain is adjusted to be 10% of the baseline gain, or 1/10 of the baseline gain, and for ion signal intensities that are expected to be greater than the predefined threshold by a factor in a range of about 5 to 2.5, the gain is adjusted to be 20% of the baseline gain, or ⅕ of the baseline gain, etc.

In some embodiments, the mass spectrometer is operated in an MS/MS mode in which at least a precursor ion is fragmented (dissociated) to produce a plurality of product ions. By way of example, electron activation dissociation (EAD) can be used to cause dissociation of the precursor ion. In some such embodiments, in addition to the product ions, the ToF mass analyzer can also receive residual precursor ions. Further, in some cases, the EAD process can also cause a charge reduction in the precursor ion without causing its dissociation, thereby generating a plurality of charge reduced species. In such cases, at least a portion of the residual precursor ions and/or the charge reduced species generated via charge reduction of the precursor ions are received by the ToF mass analyzer. In many cases the ion detection signals associated with the residual precursor ions and/or the charge reduced species can exhibit a high intensity. Thus, in some embodiments, a fraction of the baseline gain can be selected as the gain for application to ion detection signals corresponding to the residual precursor ions and/or the charge reduced species. For example, such residual precursor ions and/or charge reduced species can be identified in a survey scan and the gain can be adjusted when the data acquisition corresponds to an m/z range in which the respective ion detection signals are present. Further, in other examples the relative ratio of the precursor ion intensity or charge reduced ion intensity compared to intensity of the ion fragments can be estimated from the reaction parameters. In such cases, the adjustable gain can be selected without performing the survey scan.

In some cases, the ions analyzed by the ToF mass analyzer during an ion extraction event can include a mixture of product ions, residual precursor ions and charge reduced species. In some such cases, the residual precursor ions can be present in the mixture at a fraction (relative to the total number of ions) in a range of about 1% to about 90%, e.g., in a range of about 5% to about 80%, or in a range of about 10% to about 70%, or in a range of about 20% to about 60%, or in a range of about 30% to about 50%.

In some embodiments, at least a portion of the ions received by the ToF mass analyzer can be subjected to trapping and subsequent release prior to their arrival at the ToF mass analyzer. Such trapping and release of the ions results in generation of a temporally discontinuous ion beam for delivery to the ToF mass analyzer such that the mass analyzer receives substantially all ions during ‘signal’ periods and substantially no ions during time intervals between the ‘signal’ periods. By way of example, and without limitation, the ‘signal’ periods can be defined as contiguous time periods in which at least 90% of all ions are arriving in the ToF mass analyzer, and conversely the periods with no ions can be defined as contiguous time periods in which not more than 10% of ions are detected.

The ToF mass analyzer's utilization can then be defined as a ratio of ‘signal’ periods to the total cycle time (‘signal’ period combined with the period of no ions) and such a ratio can be termed as dwell time. In some such cases, a dwell time selected for acquisition of the ion detection signals can be any of below 90%, or below 80%, or below 70%, or below 60%, or below 50%, or below 40%, or below 30%, or below 20%, or below 10%, or below 5%, or below 1% for the signal periods.

The adjustable gain can be generated by an amplifier and/or an attenuator. For example, in some embodiments, an amplifier can provide the baseline gain at a particular amplification level and the amplification level can be reduced, when required, to provide a gain at a fraction of the baseline gain. In some cases, a discrete number of amplification levels can be predefined and chosen for application to ion detection signals based on a predefined protocol, e.g., based on various signal intensity ranges.

In various embodiments, the gain switching is performed within a single ToF extraction event. In various embodiments, intense signals acquired at low gain settings can be temporally spaced from the other signals acquired at the baseline gain setting by few tenths of nanoseconds (See, e.g., attached FIG. 5F and the associated description). Thus, in such embodiments, the gain switching function needs to provide a sufficiently fast switching to allow adjusting the gain of temporally close ion detection signals based on their intensities.

In some such embodiments, the gain can be generated using two gain devices, e.g., two amplifiers, that are positioned in series or in parallel. For example, two amplifiers positioned in series (in tandem) can be configured to collectively function as a single amplification unit for providing a gain profile of interest. For example, the gain profile of one of the amplifiers can be switched from a high gain mode (e.g., a mode at which the combined gain corresponds to the baseline gain) to a low gain mode (e.g., a mode at which the combined gain corresponds to a fraction of the baseline gain) at a first predefined time during data acquisition and the gain profile of the other amplifier can be switched from a low gain mode (e.g., a mode at which the combined gain corresponds to a fraction of the baseline gain) to a high gain mode (e.g., a mode at which the gain corresponds to the baseline gain) during a second time during data acquisition so as to cooperatively provide the fraction of the baseline gain during a time interval extending between the first time and the second time.

In some embodiments, the step of applying the adjustable gain includes configuring two amplifiers positioned in parallel to provide different gains and routing the ion detection signals in parallel data streams to those two amplifiers to generate two sets of amplified ion detection signals at different gains and independently digitizing the two sets of the amplified ion detection signals to generate two sets of digital ion detection signals. The two sets of the digital ion detection signals can be processed to generate a single mass spectrum of the ions.

In some embodiments, the adjustable gain for application to an ion detection signal can be determined based on both an expected intensity of that ion detection signal as well as the sensitivity of an ion detector utilized for the detection of the signal, that is, the sensitivity of the ion detector at an m/z ratio corresponding to that of the ion.

In some embodiments, the step of processing the digital gain-adjusted ion detection signals includes calibrating an m/z ratio associated with each of the digital gain-adjusted ion detection signals as a function of the gain associated with that signal.

In some embodiments, the fraction of the baseline gain for application to an ion detection signal can be selected from a set of predefined fractions. In some such embodiments, the calibration of the ion detection signals can be based on the previously-obtained calibration data for those fractional gains. By way of example, for each gain value, the degree of deviation of an m/z ratio in a mass spectrum of a calibrant obtained at that gain from known m/z ratio of the calibrant can be determined and used as calibration data.

In some embodiments, an analog-to-digital converter (ADC) can be employed for digitizing the gain-adjusted ion detection signals. In such embodiments, the gain for application to the ion detection signals is selected such that the gain-adjusted signals have intensities that exceed a lower end of the ADC's dynamic range.

As noted above, a survey scan can be utilized to determine the expected intensities of the ion detection signals. In such cases, in some embodiments, the gain for use during the survey scan can correspond to the lowest fraction of the baseline gain that allows digitization of the ion detection data by the ADC.

In a related aspect, a system for use in a mass spectrometer for acquisition of mass data using a time-of-flight (ToF) mass analyzer is disclosed, which includes an ion detector configured to detect ions and generate ion detection signals in response to the detection of ions during each of a plurality of ion extraction events and at least one gain device operably coupled to the ion detector for applying an adjustable gain to the ion detection signals to generate gain-adjusted ion detection signals. The system can further include a controller in communication with the at least one gain device and configured to send one or more control signals based on an expected intensity of each ion detection signal to the gain device such that the gain device applies one of a baseline gain and a fraction of baseline gain to that ion detection signal, thereby generating a plurality of gain-adjusted ion detection signals.

In some embodiments, the system includes an analog-to-digital converter (ADC) for digitizing the gain-adjusted ion detection signals and generating a plurality of digital gain-adjusted ion detection signals. An analyzer can receive the digital gain-adjusted ion detection signals and can process those signals to correct for variations, if any, in the gain applied to the ion detection signals. The analyzer can be further configured to process the corrected digital gain-adjusted ion detection signals to generate a mass spectrum associated with the ion detection signals.

By way of example, in some embodiments, the analyzer is configured to apply a scaling factor to an intensity of each of the digital gain-adjusted ion detection signals to correct for variations, if any, in the gain applied to the ion detection signals. By way of example, the scaling factor for application to each of the digital gain-adjusted ion detection signals can correspond to a ratio of the baseline gain to the gain associated with that signal.

In some embodiments, the mass spectrometer is configured to operate in an MS/MS mode. In some such embodiments, the mass spectrometer can include an EAD module that is configured to receive at least one type of precursor ions and cause dissociation of the precursor ions to generate a plurality of product ions. In some cases, some of the precursor ions remain undissociated. Further, the EAD module can also cause a charge reduction in a portion of the precursor ions to generate a plurality of charge reduced ions (herein also referred to as charge reduced species). In some such embodiments, the controller can be configured to send one or more control signals to the gain device to instruct the gain device to apply a fraction of the baseline gain to the ion detection signals corresponding to the undissociated precursor ions and the charge reduced ions. In some cases, the gains applied to the ion detection signals associated with the precursor and charge reduced ions can be substantially the same while in other embodiments they can be different.

In some cases, the gain device can include two gain devices, e.g., two amplifiers, that are coupled in series. In some such embodiments, the controller is configured to adjust a temporal gain profile of each of the two gain devices so as to apply a desired gain to each of the ion detection signals. For example, the controller can cause the gain profile of one of two tandem amplifiers to transition from a high gain mode (e.g., a mode in which the amplifier provides the baseline gain) to a low gain mode (e.g., a mode in which the amplifier provides a fraction of the baseline gain) at a first time during the data acquisition and to cause the gain profile of the other amplifier to transition from the low gain mode to the high gain mode so as to provide a desired gain (e.g., a low gain) at a second time such that the combination of the transitions in the two gain profiles provides a desired gain in the time interval between the first and the second times. For example, the resultant gain may be low during this time interval and be high before and after this time interval.

In some embodiments, the two gain devices can include two amplifiers that are configured to receive, in parallel, the ion detection signals from an ion detector and generate amplified signals. The output of each amplifier can be delivered to a separate ADC to generate two digitized data streams, where each data stream includes digital gain-adjusted ion detection signals associated with the gain profile of the respective amplifier. More specifically, the amplifiers can be operated with different gain profiles such that the two digitized data streams exhibit different gain profiles, wherein intense ion detection signals are acquired at low gains for both data streams and the remaining signals are acquired at baseline gain in at least one data stream, and at low gain in the other data stream. In some such cases, the resulting mass spectrum can be constructed using the intense signal from any of the data streams, and the remaining signal from the data stream with the baseline gain.

In another aspect, a method of performing mass spectrometry is disclosed, which includes using an ion detector of a mass spectrometer to generate a plurality of ion detection signals and applying an adjustable gain to said ion detection signals, wherein said adjustable gain is determined based on variation of a sensitivity of the ion detector as a function of m/z ratio of ions detected by the ion detector. By way of example, in some embodiments, the adjustable gain can be selected so as to substantially compensate for the variation of the ion detector's sensitivity as a function of m/z ratio.

Further understanding of various aspects of the present teachings can be obtained with reference to the following detailed description in conjunction with the associated drawings, which are described briefly below.

### BRIEF DESCRIPTION OF THE DRAWINGS

FIG. 1A shows a hypothetical MS/MS spectrum containing mass detection signals corresponding to a precursor ion and a plurality of fragment ions generated via dissociation of the precursor ion,

FIG. 1B schematically depicts the application of a constant gain for application to the mass detection signals shown in the mass spectrum depicted in FIG. 1A,

FIG. 1C shows a mass spectrum obtained via application of the constant gain to the mass detection signals depicted in FIG. 1A,

FIG. 2 is a flow chart depicting various steps in an embodiment of a method according to the present teachings for performing mass spectrometry,

FIG. 3A shows a hypothetical mass spectrum containing a precursor mass peak and a plurality of mass peaks corresponding to fragment ions,

FIG. 3B shows an example of an in-spectrum adjustable gain as function of time that can be applied to the mass detection signals depicted in FIG. 3A to generate the gain-adjusted mass spectrum depicted in FIG. 3C,

FIG. 4A shows the gain-adjusted mass spectrum presented in FIG. 3C,

FIG. 4B shows a corrective gain function that can be applied to the mass detection signals in the mass spectrum depicted in FIG. 4A, e.g., during post-processing of the mass data, to arrive at the mass spectrum depicted in FIG. 4C in which the correct relative signal intensities of the mass detection signals are provided,

FIG. 5A schematically depicts a system according to an embodiment for performing mass spectrometry,

FIG. 5B schematically depicts a system according to an embodiment of the present teachings in which a pair of tandem amplifiers are employed for applying an adjustable gain to ion detection signals,

FIG. 5C shows an example of a temporal gain profile associated with one of the amplifiers depicted in FIG. 5B,

FIG. 5D shows a resultant gain profile generated via a combination of the gain profiles of the two amplifiers as depicted in FIGS. 5B and 5C,

FIG. 6A schematically depicts an embodiment according to the present teachings in which two amplifiers arranged in parallel are employed for applying adjustable gains to a plurality of ion detection signals generated by an ion detector,

FIG. 6B shows an example of a temporal gain profile associated with one of the amplifiers shown in FIG. 6A,

FIG. 6C shows an example of a temporal gain profile associated with the other amplifier shown in FIG. 6A,

FIG. 6D shows a resultant temporal gain profile generated via a combination of the gain profiles shown in FIG. 6A,

FIG. 7 schematically depicts an example of an implementation of a controller suitable for use in various embodiments,

FIG. 8 schematically depicts a mass spectrometer according to an embodiment of the present teachings,

FIG. 9A is a hypothetical example of a gain adjustment function that can be applied to ion detection signals to compensate for variations in the gain of an ion detector utilized to generate those ion detection signals,

FIG. 9B is a hypothetical example of a gain adjustment function that can be applied to ion detection signals to lower the gain relative to a baseline region in an m/z region in which ion detection signals with high intensities are present,

FIG. 9C depicts a combination of the gain adjustment functions depicted in FIGS. 9A and 9B,

FIG. 9D shows a hypothetical continuously-varying linear gain adjustment function as well as a staircase gain adjustment function that can be used as an approximation of the continuously-varying gain adjustment function,

FIG. 10 presents data corresponding to typical arrival time distributions of ions subjected to an EAD ion fragmentation reaction at a downstream time-of-flight (ToF) mass analyzer,

FIG. 11 shows an example of an EAD spectrum of a singly charged lipid species,

FIG. 12 shows an example of raw unprocessed data acquired around a precursor with a high abundance exhibiting a clipped precursor mass signal, followed by an undershoot zone of silence (no discernible signals) and followed by a significantly elevated baseline, which stays above threshold for more than 10 microseconds, and

FIG. 13 shows the mass spectrum of protonated precursor ion [M+3H]³ as well as several fragment ions generated via electron capture dissociation of the protonated precursor ion.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or less than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

The term “dynamic adjustment of gain” and similar phrases, as used herein, refer to the adjustment of a gain applied to ion detection signals associated with a mass spectrum during acquisition of mass detection data.

The terms “ion extraction event,” or “extraction event” as used herein refer to detection of a packet of ions deflected by a deflector of a time-of-flight (ToF) mass analyzer via application of an acceleration pulse to the deflector.

The term “gain device,” as used herein, refers to an amplifier or an attenuator that can amplify or attenuate an ion detection signal.

The terms “mass detection signal” and “ion detection signal” are used herein interchangeably to refer to a signal generated by an ion detector in response to incidence of one or more ions thereon.

The term “gain-adjusted ion detection signal” refers to a signal whose intensity has been modified, e.g., amplified or attenuated, relative to a previous intensity value.

The term “duty cycle” as used herein can be defined as a ratio of the sum of data acquisition time containing ion detection signals with intensities above a predefined threshold relative to the total data acquisition time.

The term “sensitivity of an ion detector” as used herein is intended to indicate a relative response of the detector based on a single ion strike of a specific ion type detected at known m/z value.

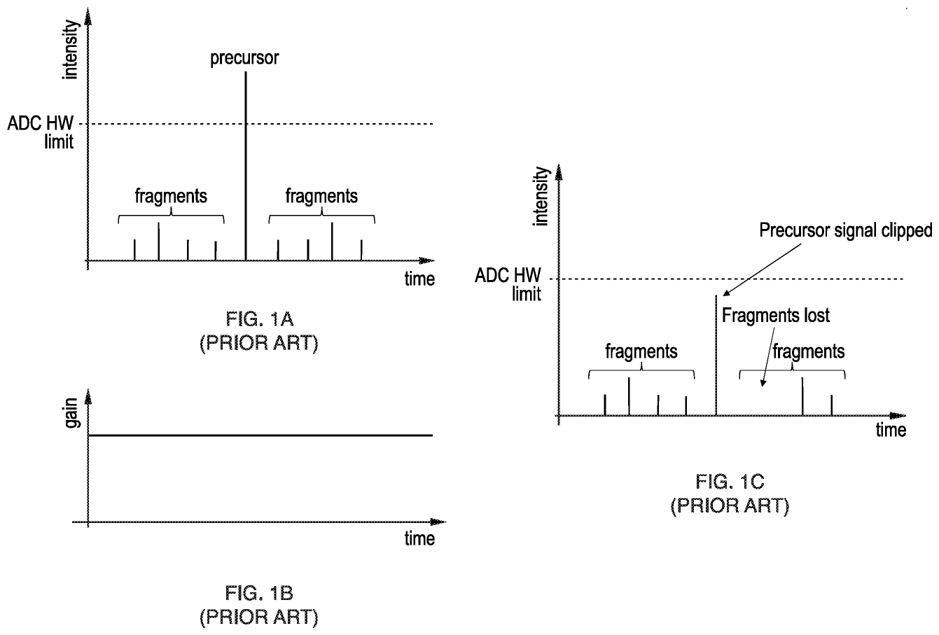

FIG. 1A schematically depicts an example of a mass spectrum that includes a mass signal (herein also referred to as a mass peak) associated with a precursor ion and a number of mass signals associated with fragment ions generated via the fragmentation of the precursor ion. As shown in FIG. 1B, in conventional systems, a constant gain is applied to all the mass peaks within the spectrum. In some cases, this can lead to distortions in the resultant gain-adjusted spectrum, as shown by way of example in FIG. 1C. For example, FIG. 1C shows that the amplified signal corresponding to the precursor mass peak exceeds the upper limit of the dynamic range of an analog-to-digital converter (ADC) utilized to digitize the signal, thereby resulting in the clipping of the signal. Further, the mass signal associated with one of the fragment ions is lost in the amplified digitized signal due to lack of sufficient time to recover following the receipt of a very intense signal, resulting in a zone of silence.

The present disclosure is generally directed to in-spectrum dynamic adjustment of a gain applied to mass detection signals generated during acquisition of mass to charge data, and more particularly to such mass detection signals that are generated by a detector of a time-of-flight mass analyzer during an ion extraction event. In some embodiments, the adjustment of the gain can be achieved dynamically by adjusting the gain of an amplifier/attenuator that receives the mass detection signals and applies a gain to the mass detection signals. By way of example, in some such embodiments, a digital gain amplifier can be utilized, where the gain of the amplifier can be switched within a time period of a few nanoseconds, e.g., less than about 10 or 5 nanoseconds.

In other embodiments, two or more amplifiers/attenuators each providing a different gain can be employed to adjust the gain applied to the ion detection signals. As discussed in more detail below, the adjustment of the gain applied to the mass detection signals can be based on m/z regions associated with the mass detection signals, e.g., it can be based on the expected maximum intensity of ion detection signals in an m/z region. For example, in an MS/MS analysis, the intensity of the ion detection signals associated with precursor ions can be significantly greater than the intensity of the ion detection signals associated with fragment ions generated via fragmentation of those precursor ions. In such cases, a method according to an embodiment of the present teachings can be utilized to adjust the gain applied to the ion detection signals such that the gain applied to the ion detection signals associated with the precursor ions is less than the gain applied to the ion detection signals associated with the fragment ions. Further, in some cases, a gain applied to an ion detection signal can be less than a reference gain (herein also referred to as a baseline gain) so as to attenuate the signal intensity. As discussed in more detail below, in some embodiments, the gain applied to the ion detection signals can be adjusted relative to a baseline gain. In various embodiments, the baseline gain can be selected based on a gain required to ensure that the expected lowest signal intensity will be sufficiently amplified to be greater than the lower end of a dynamic range of an analog-to-digital converter (ADC) utilized to digitize amplified signals.

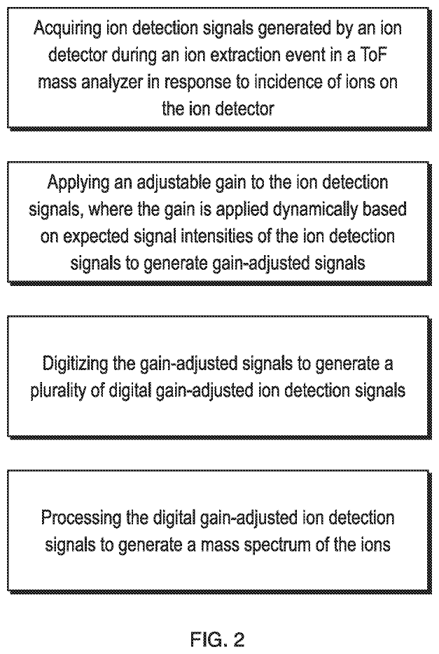

FIG. 2 is a flow chart depicting various steps in a method according to an embodiment for performing mass spectrometry, which includes acquiring ion detection signals generated by an ion detector during an ion extraction event in a time-of-flight (ToF) mass analyzer in response to incidence of ions thereon, and applying an adjustable gain to the ion detection signals, where the step of applying the adjustable gain to the ion detection signals is performed dynamically based on the expected intensities of the ion detection signals. By way of example, the adjustable gain for application to an ion detection signal can be set based on an expected signal intensity of that ion detection signal.

With continued reference to the flow chart of FIG. 2, in some embodiments, the gain-adjusted ion detection signals can be digitized to generate digital gain-adjusted ion detection signals. Further, the digital gain-adjusted ion detection signals can be processed to generate a mass spectrum of the ions. By way of example, in some embodiments, the digital signals can be corrected for variations, if any, in the gain applied to different ion detection signals to generate corrected ion detection signals, which can then be processed to generate the mass spectrum of the ions.

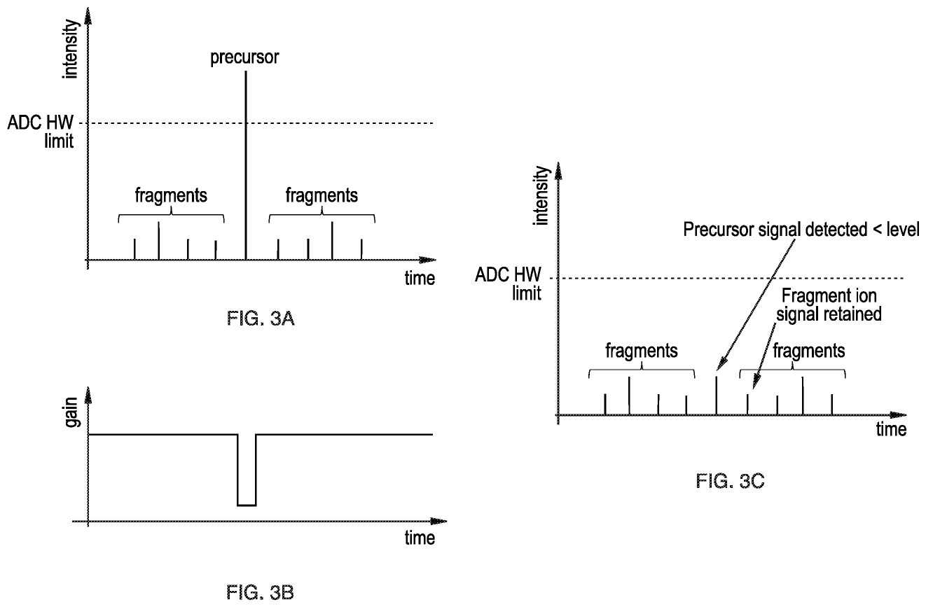

By way of illustration of an example of application of a method according to the present teachings for providing in-spectrum adjustment of the gain applied to mass detection signals, FIG. 3A shows the same hypothetical mass spectrum shown in FIG. 1A. Unlike the conventional methods of applying the same uniform gain to all the mass peaks within a spectrum, in this example, the gain applied to the mass detection signals is adjusted dynamically as shown schematically in FIG. 3B. In particular, the gain is reduced in an m/z region around the mass peak corresponding to the precursor ion to ensure that the amplified precursor ion detection signal can be digitized via the ADC without distortion while sufficient gain is applied to the mass peaks corresponding to the fragment ions, as shown schematically in FIG. 3C.

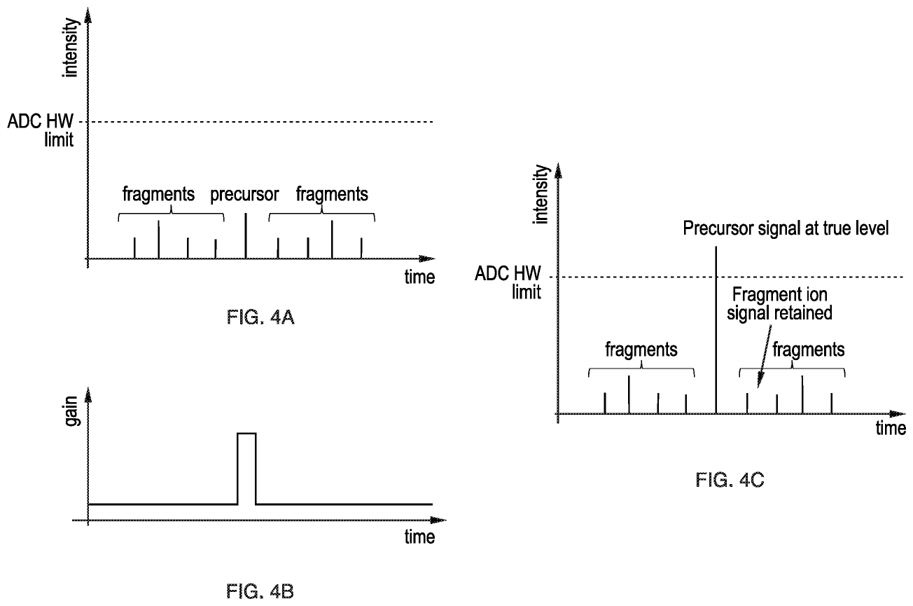

In some embodiments, a mass spectrum obtained via in-spectrum dynamic adjustment of gain applied to the mass detection signals can be processed (decoded) to obtain the correct relative intensities of the mass signals (i.e., relative intensities if a constant gain had been applied to all the mass peaks). By way of illustration, FIG. 4A shows the mass spectrum depicted in FIG. 3C, which is obtained, as discussed above, via increasing the gain in an m/z region around the m/z value of the precursor ion. Application of a gain as a function of m/z shown in FIG. 4B to the mass spectrum depicted in FIG. 4A can reconstruct mass spectrum depicted in FIG. 4C in which the mass signals exhibit correct relative peak intensities. In particular, the gain function depicted in FIG. 4B results in the application of a greater gain to the mass peak corresponding to the precursor ion relative to the mass peaks associated with the fragment ions. The ratio of the gain applied to the mass peak associated with the precursor ion relative to the gain applied to the fragment ions is substantially inverse of the respective gain ratio depicted in FIG. 3B.

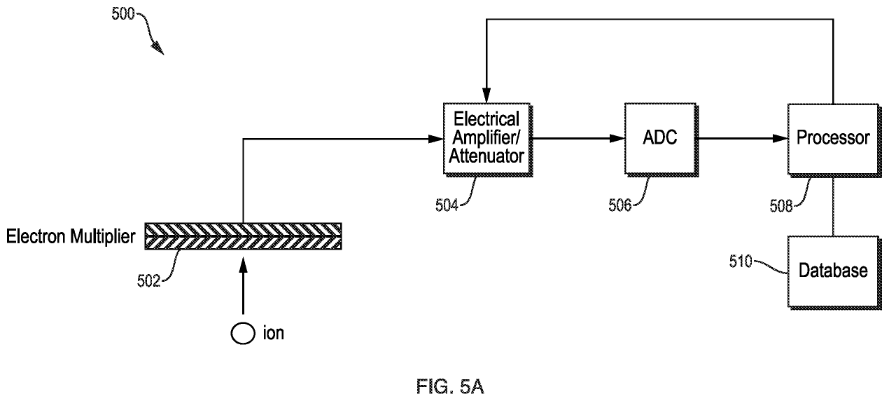

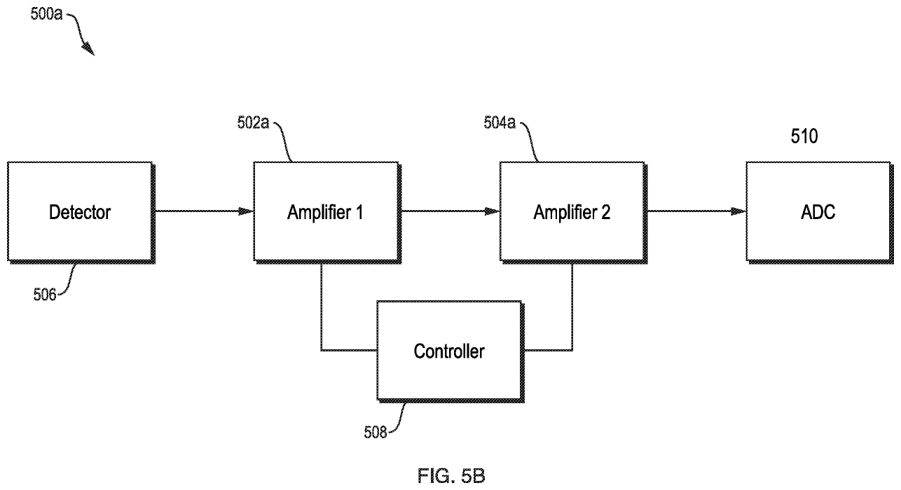

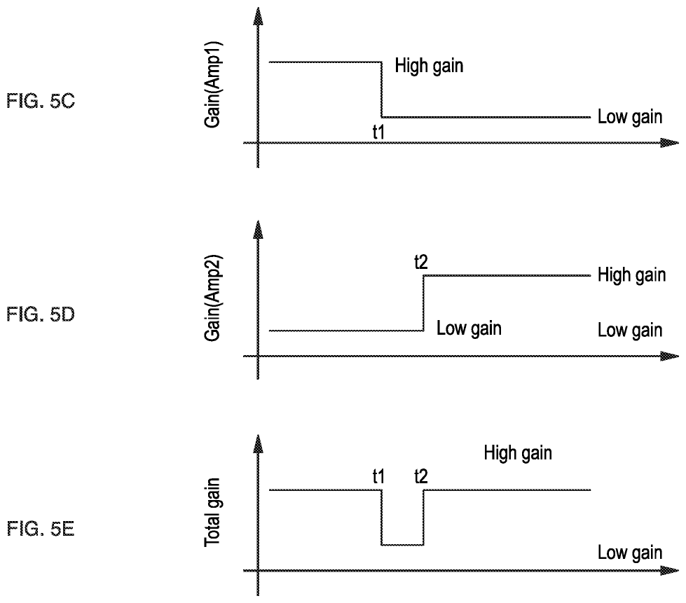

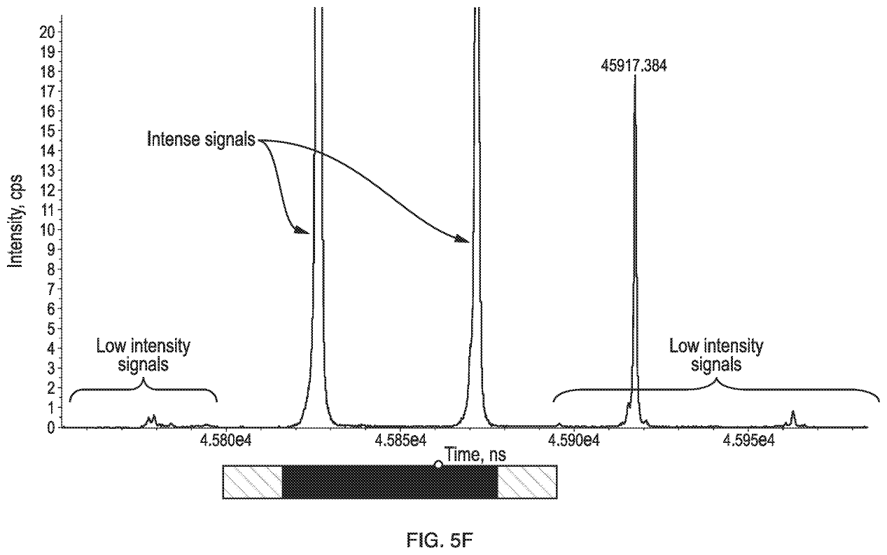

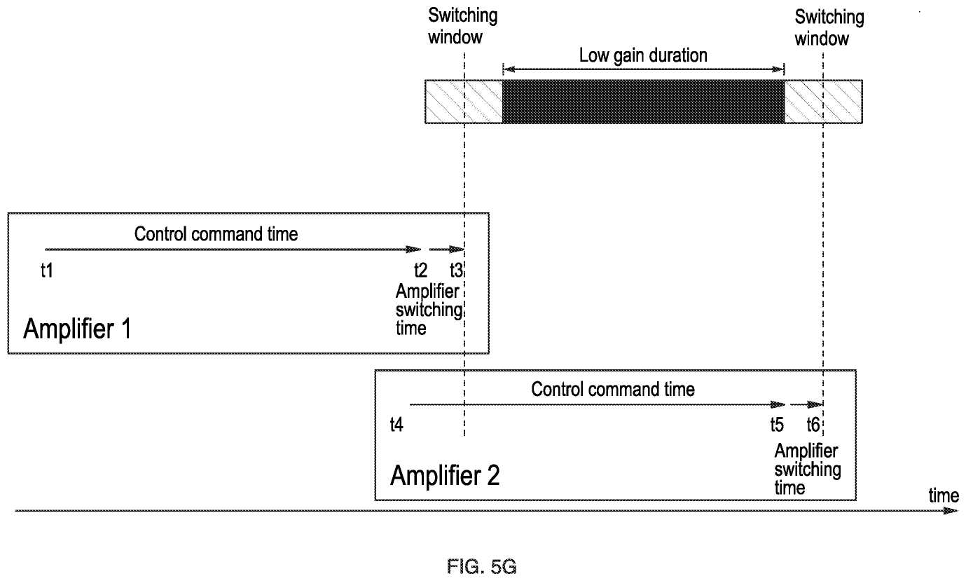

FIG. 5A schematically depicts a system 500 according to an embodiment for use in a mass spectrometer for data acquisition and processing, which includes an ion detector 502, an electron multiplier in this embodiment, that can generate ion detection signals in response to incidence of ions thereon. In some embodiments, such an ion detector can be employed in a ToF mass analyzer to receive ions deflected by an ion deflector of the mass analyzer toward the ion detector.

An electrical amplifier/attenuator 504 can receive the ion detection signals generated by the ion detector and apply an adjustable gain to those ion detection signals to generate gain-adjusted ion detection signals. In this embodiment, the amplifier/attenuator 504 is an analog amplifier/attenuator that generates analog gain-adjusted ion detection signals. An analog-to-digital converter (ADC) 506 receives the analog gain-adjusted ion detection signals and converts the analog signals to digital signals (herein also referred to as digital ion detections signals or digital gain-adjusted ion detection signals).

A controller/processor 508 is in communication with the amplifier/attenuator 504 to provide control signals to the amplifier/attenuator for adjusting the gain applied by the amplifier/attenuator to the ion detection signals generated by the detector, in a manner disclosed herein. The controller/processor 508 can also be configured to process the digital ion detection signals to generate a mass spectrum corresponding to the ion detection signals.

By way of example, the controller can receive gain-adjustment reference data, e.g., from a database 510 in communication with the controller, that provides the controller with information regarding the gain for application to the ion detection signals as a function of various m/z regions within a mass spectrum, e.g., various m/z regions covered in an ion extraction event in a ToF mass analyzer. In other words, the expected ion signal intensities in various m/z regions associated with an ion extraction event can inform the gain utilized for use in each of those regions.

By way of example, the expected ion signal intensities can be determined based on reference mass data in a mass survey scan performed at a low gain, which provides information regarding m/z regions in which mass signals are present as well as relative signal intensities of such mass signals in various m/z regions of the survey scan. For example, the survey scan can provide data corresponding to mass peaks associated with one or more precursor and/or fragment ions within an m/z region associated with a ToF extraction event.

The controller can utilize the reference data to apply control signals to the amplifier/attenuator for in-spectrum adjustment of the gain, e.g., during acquisition of a mass spectrum associated with an extraction event of a ToF mass analyzer.

In some embodiments, rather than utilizing a single gain device, e.g., an amplifier, two gain devices, e.g., two amplifiers, can be used to adjust the gain applied to ion detection signals. By of example, FIG. 5B schematically depicts an example 500a of such an embodiment, which includes two amplifiers 502a and 504a that are positioned in series (i.e., in tandem) relative to one another and operate under control of a controller 508.

The ion detection signals generated by an ion detector 506 are received by the amplifier 502a, which amplifies the ion detection signals and the amplified ion detection signals generated by the amplifier 502a are received by the downstream amplifier 504a, which further amplifies the amplified ion detection signals provided by the amplifier 502a to generate the resultant gain-adjusted ion detection signals, which are then digitized by an ADC 510.

With reference to FIGS. 5C, 5D, and 5E, the controller can be programmed to adjust the gain profiles of the amplifiers 502a and 504a so as to adjust the resultant gain applied to the ion detection signals. By way of illustration, in this example, the controller causes the gain of the amplifier 502a to be switched from a high gain value (e.g., a gain equal to the baseline gain) to a low gain value (e.g., a predefined fraction of the baseline gain) at time t₁ during data acquisition and causes the gain of the amplifier 504a to be switched from a low gain value to a high gain value at time t₂ during data acquisition. The combination of the switching of the gains of the two amplifiers results in a reduction of the gain from the high gain value to the low gain value during a time interval spanning from t₁ to t₂. By way of example, such a reduction in the resultant gain in this time interval may be desired due to an expected high intensity associated with at least one ion detection signal that will be observed in this time interval (which can be correlated to a particular m/z range). As noted above, in various embodiments, the presence of an ion detection signal in this time interval and its expected ion intensity can be inferred from data acquired via a survey scan. It should be noted that in this example the initial states of the amplifiers will be reversed by the switching process, i.e., the amplifier 502a that is initially operating in a high gain mode is switched to a low gain mode. Conversely, the amplifier 504a that is initially operating in a low gain mode is switched to a high gain mode such that at the end of the ion extraction event the gain status of the two amplifiers has been switched.

Since the amplifiers 502a and 504a are interchangeable in this implementation, when the next gain switching is required the switching process will proceed in reverse, i.e., the amplifier 504a switches from high gain to low gain, followed by the amplifier 502a switching from low gain to high gain. Such switching protocol allows for nearly continuous signal acquisition with preferred gain, suitable for detection of multiple intense regions within a single ToF ion extraction event.

By way of further illustration of the need for the adjustment of gain applied to ion detection signals and the way the above two tandem amplifiers can be utilized to achieve such a gain adjustment, FIG. 5F shows an MS/MS mass spectrum of a human ACTH clip 18-39 ion obtained using Sciex prototype 7600 ZenoToF mass spectrometer, which is presented in intensity/arrival time domain. The depicted mass spectrum contains several low intensity ion signals and two high intensity ion signals having peak intensities that exceed the upper end of the dynamic range of an ADC that was utilized for signal digitization. Each of the dashed squares depicts a preferred gain switching time interval associated with one of the two tandem amplifiers in order to avoid spectral distortions of the high intensity ion signals. In this example, the switching time should be less than about 20 ns. The solid rectangle extending between the two dashed squares represents a typical low gain duration.

The dashed squares show preferred temporal intervals for causing the switching in the gain of one of the two tandem amplifiers. The solid rectangle extending between the two dashed squares represents a typical duration of “low’ gain setting, which is in this example less than about 70 ns.

More specifically, FIG. 5G shows that in this example, the switching of the gain applied to the ion detection signals can be achieved by initiating the transmission of a control signal at time t₁ to the amplifier 502a such that the control signal arrives at the amplifier 502a at time t₂ and causes the amplifier's gain to switch at time t₃ from a high gain mode to a low gain mode. As the amplifier 504a is initially in a low gain mode, the combined gain associated with both amplifiers 502a/504a results in application of a low gain to the ion detection signals during the low gain interval. With continued reference to FIG. 5G, at time t₄ a control signal is initiated for transmission to the amplifier 504a and arrives at that amplifier at time t₅ to cause a switching of the gain of the amplifier 504a from a low gain mode to a high gain mode at time t₆. Thus, in various embodiments, two amplifiers with fast gain switching (with a switching time less than the switching window duration) but slow switching control time (a switching time exceeding the switching window duration, which is the low gain duration in this example) that are arranged in tandem can provide a gain switching system with both fast gain switching time and control time.

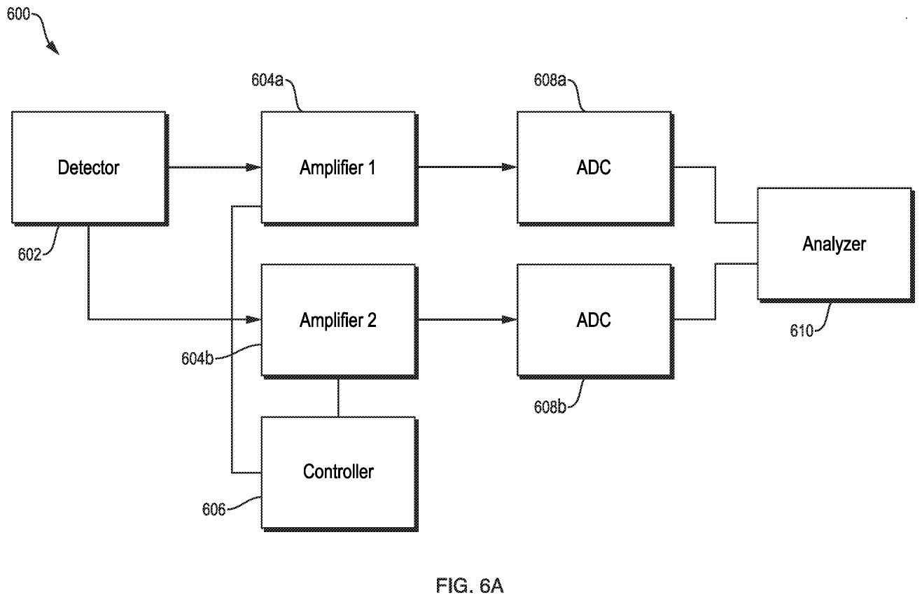

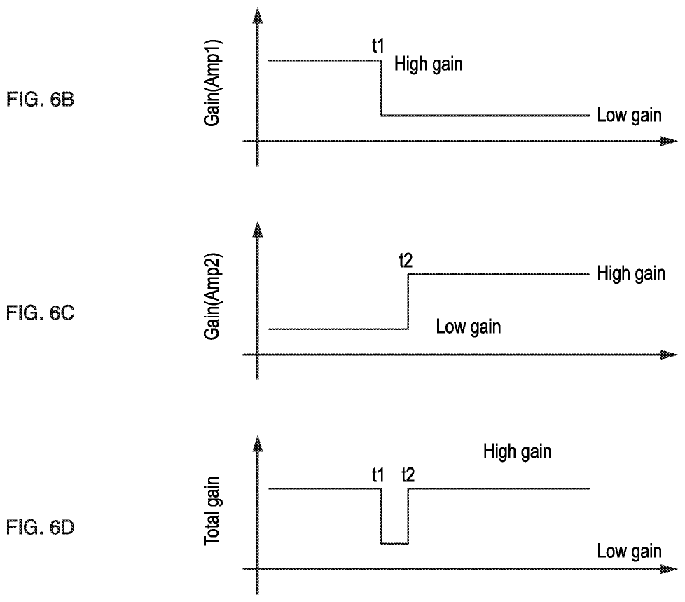

FIG. 6A schematically depicts a system 600 according to another embodiment, which similar to the previous embodiment includes two amplifiers whose gain profiles can be adjusted independently to obtain a desired gain for application to ion detection signals generated by an ion detector of a ToF mass analyzer. In this embodiment, the ion detection signals generated by an ion detector 602 of a ToF mass analyzer are sent via two parallel data streams to two amplifiers 604a and 604b. A controller 606 is in communication with the amplifiers 604a and 604b to adjust the gain profiles of the amplifiers so as to adjust the gain applied to the ion detection signals, if needed. The amplified ion detection signals generated by the amplifier 602a are received by an ADC 608a and the ion detection signals generated by the amplifier 602b are received by another ADC 608b. The ADC 608a and 608b generate two independent streams of digitized data corresponding to the amplified ion detection signals. An analyzer 610 receives the digital data streams and processes the data to generate a mass spectrum corresponding to the ion detection signals.

As noted above, in various embodiments, one advantage of the present teachings of in-spectrum gain adjustment is the prevention of distortion of a spectral line associated with an intense mass signal. In particular, in various embodiments, the high intensity signal is gain adjusted, e.g., in both signal streams.

By way of example and with reference to FIGS. 6B and 6C, the controller 604 causes a change in the gain profile of the amplifier 604a from a high gain mode (e.g., the baseline gain) to a low gain mode (e.g., a fraction of the baseline gain) at time t₁ during data acquisition. Further the controller causes a change in the gain profile of the amplifier 604b from a low gain mode (e.g., a fraction of the baseline gain) to a high gain mode (e.g., the baseline gain) at time t₂ during data acquisition. Accordingly, a portion of the data streams between acquisition times t₁ and t₂ is amplified at a low gain by both amplifiers, as shown in FIG. 6D.

Referring again to FIG. 6A, as noted above, the digital data streams generated by the ADCs 608a and 608b are processed by the analyzer 610 to generate a mass spectrum based on the ion detection signals. More specifically, in this example, the controller generates a combined data stream via stitching together different portions of the data streams generated by the ADCs 608a and 608b. One example of data stitching utilizes the data from the first data stream for all signals arriving before t₁ and combines them into a mass spectrum without application of any scaling, then utilizes the data between t₁ and t₂ from the first data stream, applies appropriate scaling and incorporates that data in the mass spectrum. Finally, the data from the second data stream is utilized for signals arriving after t₂ and that data is incorporated with the previous data to obtain a resultant mass spectrum.

In some embodiments, the selection of a gain for application to an ion detection signal is based not only on an expected intensity of that ion detection signal but also on variations, if any, in the sensitivity of an ion detector utilized for the generation of the ion detection signal as a function of m/z ratios of ions. By way of example, in some embodiments, an ion detector of a ToF mass analyzer can exhibit a variation in its sensitivity for detection of ions as a function of m/z ratio. For example, the sensitivity of the ion detector may decease as the m/z ratio of the incident ions increases. By way of example, such a decrease can be linear or non-linear.

In such cases, the controller can be programmed to take into account such variations of the ion detector's sensitivity for determining a gain to be applied to an ion detection signal. For example, if the expected intensity of an ion detection signal associated with an ion having a particular m/z ratio is sufficiently high so as to necessitate the reduction of the gain below the baseline gain, the degree of reduction will be estimated not only based on the expected intensity of the ion detection signal but also based on variations, if any, of the sensitivity of an ion detector utilized for the detection of that ion. By way of illustration, in absence of any variation in the sensitivity of an ion detector, a reduction of the gain by about 10% relative to the baseline gain may be required for application to an ion detection signal. However, if the sensitivity of the ion detector for the detection of the ions would exhibit a reduction relative to its maximum sensitivity, a reduction of less than 10%, or no reduction, in the gain to be applied to the ion detection signal may be required. Conversely, if the sensitivity of an ion detector increases for the detection of ions having m/z ratios in a particular range, such an increase in the detector's sensitivity may lead to a higher reduction in a gain to be applied to an ion detection signal associated with an ion having an m/z ratio in that range.

In a related aspect, even in absence of the need to adjust the gain applied to ion detection signals due to variations in the intensities of the ion detection signals, the gain applied to ion detection signals generated by an ion detector of a mass spectrometer may be adjusted to compensate for the variations in the detector's sensitivity. By way of example, in some embodiments, the sensitivity of an ion detector may decrease as the m/z ratio of ions increases. By way of example, the gain profile for application to the ion detection signals can increase as a function of increasing m/z ratio to substantially compensate for the decrease in the ion detector's sensitivity. Such methods of adjusting the gain to compensate for variations in the detector's sensitivity can be applicable to mass spectrometers employing ToF mass analyzers or other mass analyzers.

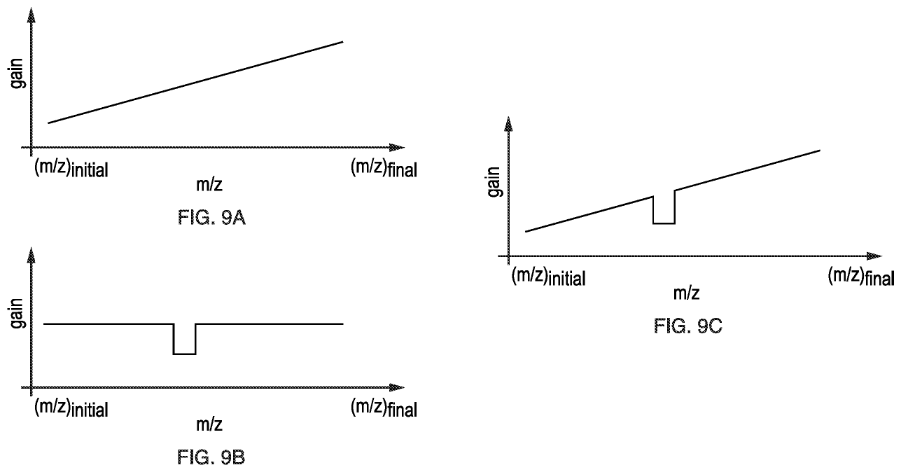

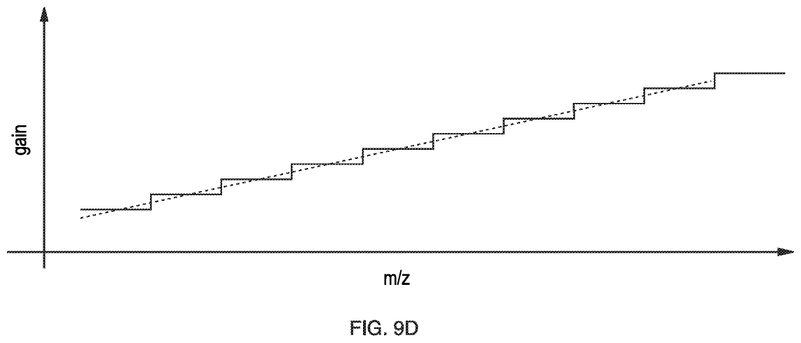

By way of further illustration, FIG. 9A depicts an example of a continuous baseline gain adjustment across an m/z range extending from (m/z)ᵢₙᵢₜᵢₐₗ and a final m/z ratio (m/z)_{final} to substantially compensate for a similar decrease in the gain of an electron-multiplier ion detector as a function of m/z ratio. Such a gain adjustment can be applied to ion detection signals even in absence of gain adjustment to compensate for variation of signal intensity.

FIG. 9B shows an example of adjusting the gain applied to ion detection signals via lowering the gain relative to a baseline gain over an m/z range extending from (m/z)ᵢₙᵢₜᵢₐₗ to (m/z)_{final}. FIG. 9C shows in turn the combination of the gain adjustments depicted in FIGS. 9A, 9B and 9C to account not only for variations in ion signal intensities but also for variations in ion detector's sensitivity.

In some embodiments, rather than applying a continuously-varying gain adjustment to ion detection signals to compensate for a change in the sensitivity of an ion detector, such as the continuous linear adjustment depicted in FIG. 9A, the gain adjustment applied to the ion detection signals can be implemented by using a discrete number of gain values over different m/z regions. By way of example, FIG. 9D shows adjusting the gain applied to ion detection signals using a staircase function to compensate for decreasing gain of an electron-multiplier ion detector. The dashed line indicates a continuously varying gain adjustment that can compensate for a respective continuous decrease in the ion detector's gain. In contrast, the staircase function shows a number of plateaus each extending over an m/z range, where the gain associated with the plateaus increases as a function of increasing m/z ratio. In some embodiments, such a staircase function can provide certain advantages. For example, as noted above, a change in the gain applied to ion detection signals may necessitate applying a different calibration factor to the ion detection signals. In this example in which a discrete number of gain values each associated with a particular m/z range is utilized, a discrete number of previously-determined calibration factors can be employed for calibrating the ion detection signals within the m/z range associated with each gain.

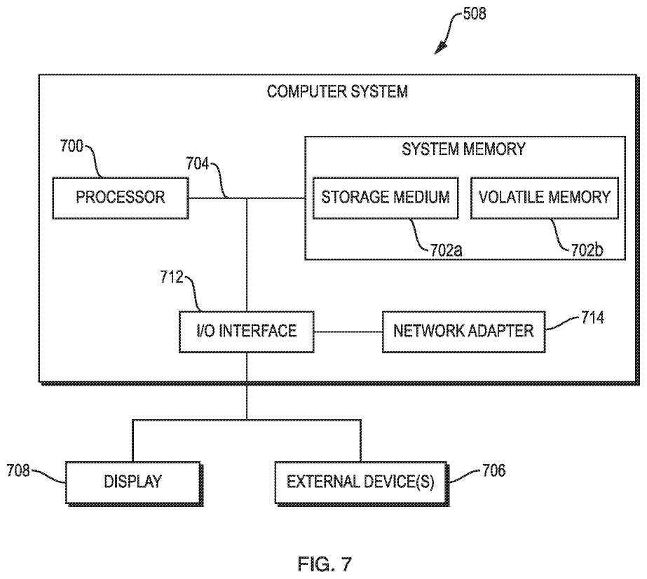

A controller according to various embodiments of the present teachings, such as the above controller 508, can be implemented in hardware, firmware and/or software using techniques known in the art as informed by the present teachings. By way of example, FIG. 7 schematically depicts an example of such implementation.

As shown in FIG. 7, the controller 508 can include one or more processors or processing units 700, a system memory 702, and a bus 704 that allows communication between various components of the controller including the system memory 702 to the processor 700.

The system memory 702 includes a computer readable storage medium 702a and volatile memory 702b (e.g., Random Access Memory, cache, etc.). As used herein, a computer readable storage medium includes any media that is capable of storing computer readable program instructions and is accessible by a computer system. The computer readable storage medium 702a includes non-volatile and non-transitory storage media (e.g., flash memory, read only memory (ROM), hard disk drives, etc.). Computer readable program instructions as described herein include program modules (e.g., routines, programs, objects, components, logic, data structures, etc.) that are executable by a processor. Furthermore, computer readable program instructions, when executed by a processor, can direct a computer system (e.g., the controller 508) to function in a particular manner such that a computer readable storage medium comprises an article of manufacture. Specifically, when the computer readable program instructions stored in the computer readable storage medium 702a are executed by the processor 700, they create means for implementing the functions specified in the present teachings.

The bus 704 may be one or more of any type of bus structure capable of transmitting data between components of the controller (e.g., a memory bus, a memory controller, a peripheral bus, an accelerated graphics port, etc.).

In some embodiments the controller 508 may include one or more external devices 706 and a display 708. As used herein, an external device includes any device that allows a user to interact with the controller (e.g., mouse, keyboard, touch screen, etc.). The external devices 706 and the display 710 are in communication with the processor 700 and the system memory 702 via an Input/Output (I/O) interface 712. In some embodiments, the controller can further include a network adapter 714 to allow establishing communication between the controller and other devices.

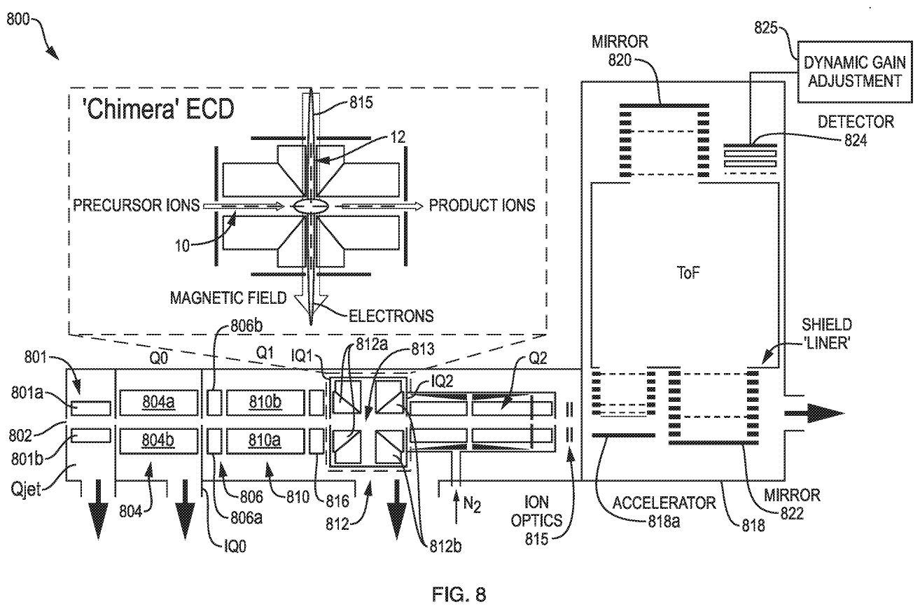

FIG. 8 schematically depicts an example of a mass spectrometer 800 according to an embodiment of the present teachings, which can be configured to perform dynamic adjustment of a gain applied to ion detections signals in a manner disclosed herein.

The mass spectrometer 800 can include an ion source (not shown) for generating ions that can be received by an ion guide Qjet via an orifice 802 of the mass spectrometer, where the Qjet ion guide includes a set of rods 801 arranged in a quadrupole configuration, two of which 801a/801b are visible in the figure and employs a combination of gas dynamics and radio frequency fields to cause focusing of the ions. The ions exiting the Qjet ion guide are received by an ion guide Q0 that includes a set of quadrupole rods 804, two of which 804a/804b are visible in the figure, to which RF voltages can be applied for causing radial confinement of the ions and generate an ion beam that is in turn received by an ion mass filter Q1. The ion guides Qjet, Q0, and the mass filter Q1 are disposed in differentially-pumped chambers that are maintained at progressively lower pressures.

An ion lens IQ0 focuses the ions exiting the Q0 ion guide into the mass filter Q1. The mass filter Q1 includes a stubby lens 806 that includes a set of quadrupole rods (two of which 806a/806b are visible in the figure) to which an RF field can be applied to cause focusing of the ions. The mass filter Q1 further includes a set of quadrupole rods 810, two of which 810a/810b are visible in the figure, to which a combination of RF and DC voltages can be applied to allow the selection of a precursor ion having a particular m/z ratio for transmission to a downstream electron reaction device 812 (herein also referred to electron reaction trap) in which the precursor ion can undergo electron capture dissociation, as discussed in more detail below. A stubby lens 814 positioned downstream of the quadrupole rod set helps focus the selected precursor ion into the downstream electron reaction device 812.

The electron reaction device 812 includes two sets of L-shaped rods 812a/812b, that are positioned with an axial offset relative to one another to provide an ion trapping region 813 therebetween. The combination of the two sets of quadrupole rods provides an axial passageway 10 and a transverse passageway 12, where precursor ions can be introduced into the trapping region 813 via an inlet of the axial passageway and product ions generated via electron capture dissociation of the precursor ions or any other electron-induced fragmentation process, such as EIEIO (electron impact excitation of ions from organics), EID (electron induced dissociation), and any remaining precursor and/or charge reduced ions can exit the ion reaction device via an outlet of the axial passageway. An electron beam 815 can be introduced into the ion trapping region 813 via an inlet of the transverse passageway to interact with ions trapped in the ion trapping region 813, where the interaction of the electrons with the trapped ions can cause dissociation of the precursor ions, e.g., via electron capture dissociation. The electron beam can exit the ion reaction device via an outlet of the transvers passageway. Further details regarding the electron reaction device and its operation can be found, e.g., in U.S. Pat. No. 10,014,166, which is herein incorporated by reference in its entirety.

The precursor ions generated in the ion trapping region 813 are received by a collision cell Q2 via an ion lens IQ2. The collision cell Q2 is pressurized via introduction of nitrogen gas to allow collisional cooling of the ions received by the cell Q2.

The ions exiting the cell Q2 are focused by a set of ion focusing optics 815 into a time-of-flight (ToF) mass analyzer 818, which can provide mass analysis of those ions. More specifically, the ToF mass analyzer 818 includes an ion deflector (herein also referred to as an accelerator) 818a that can apply an accelerating voltage to a packet of ions to cause their travel through a field free region of the ToF analyzer toward an ion mirror 820, which can deflect the ions toward an opposed ion mirror 822, which in turn directs the ions to an ion detector 824, which can generate ion detection signals in response to the detection of the ions. The ion detection signals can be processed with in-spectrum adjustable gain system 825 according to the present teachings in a manner disclosed herein, e.g., using the systems discussed above in connection with FIGS. 3, 4, and 5.

### EXAMPLES

### Example 1

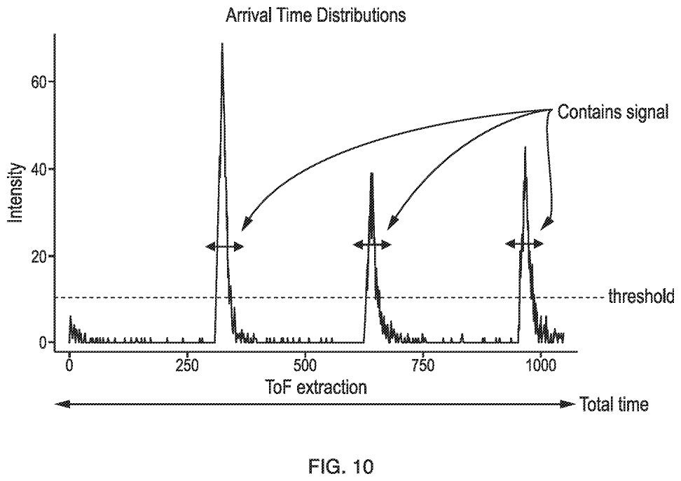

A mass spectrometer such as that depicted schematically in the above FIG. 8A was used to obtain data depicted in FIG. 10, which provides typical arrival time distributions of ions subjected to an EAD ion fragmentation reaction at a downstream time-of-flight (ToF) mass analyzer. The arrival time distributions were obtained for singly charged ions of reserpine that had undergone a 30-ms simultaneous loading and reaction in an EAD chamber and the ToF mass analyzer was pulsed at a frequency of 13.5 kHz for the detection of the product ions. Less than 30% of the ToF extractions included any mass signal with the 90% of the total signal contained in about 10% of ToF extractions. This data shows an example of ion detection signals associated with a plurality of ToF extraction pulses whose analysis can benefit from dynamic adjustment of a gain applied to the signals in accordance with the present teachings.

FIG. 10 also schematically depicts how the duty cycle can be defined in various embodiments. In particular, the duty cycle can be defined as a ratio of the sum of data acquisition time containing ion detection signals with intensities above a predefined threshold relative to the total time of data acquisition. By way of illustration, in the example depicted in FIG. 10 the threshold is defined as 10% of the expected maximum intensity of the mass peaks, though other criteria for setting the threshold may also be employed.

### Example 2

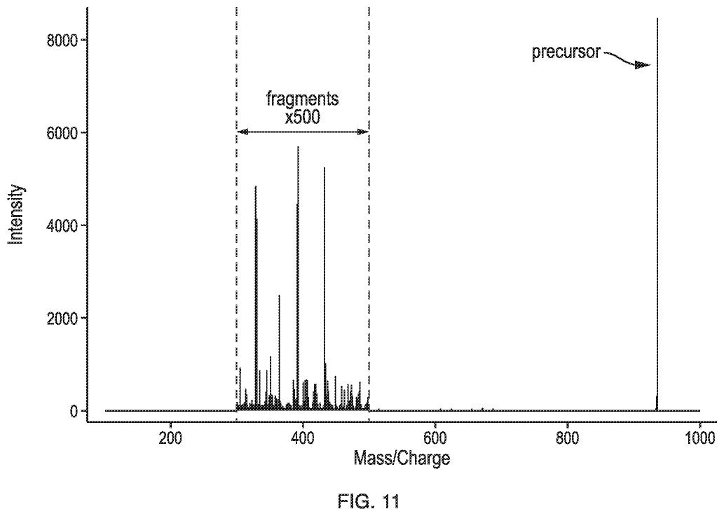

As noted above, in an EAD reaction, the total number of potential ion fragments is high and in the case of singly charged ions, precursor and fragment neutralization may occur, which can lead to a high ratio of the remaining precursor ions to fragment ions. Moreover, in the case of multiply charged ions, second fragmentation may occur, which can lead to the formation of uninformative internal fragment ions. By way of illustration, FIG. 11 shows an example of an EAD spectrum of singly charged lipid species dTAG 56-7 FA 22-6, where the ratio of a typical fragment intensity to precursor intensity is less than 1/500. Such discrepancy in precursor-to-fragment abundance, and hence signal intensity, can further exacerbate the limitations caused by in-spectrum dynamic range in conventional systems as the precursor and fragment ions need to be co-detected.

### Example 3

As discussed above, in addition to limitations imposed by dynamic range when collecting data with substantial variations in signal intensity, the acquisition of data at very high ion loads, which is generally preferable for facile detection of low abundant fragment ions, can lead to undesirable data artefacts. By way of example, such data artefacts may occur in EAD MS/MS analysis.

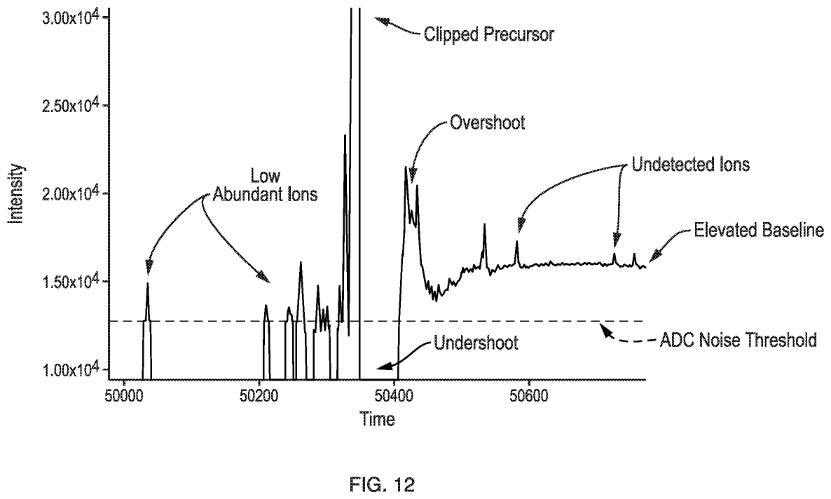

FIG. 12 shows an example of raw unprocessed data acquired around a precursor with a high abundance exhibiting a clipped precursor mass signal, followed by an undershoot zone of silence (no discernible signals) and followed by a significantly elevated baseline, which stays above threshold for more than 10 microseconds. Such an elevated baseline can present a challenge in conventional data acquisition systems, which are generally tuned for very high data rates and typically have a first processing step of data filtering. The filtering step is employed to detect the signals above the threshold and to form a packet from those datapoints often supplementing the packet by a finite number of adjacent points. Conventionally, such a packet will contain a single detection event, which will ideally correspond to an ion or a group of ions from the same species. An example of such a data packet, marked as low abundant ions, can be seen in FIG. 12.

Such data processing is, however, not suitable for processing data with an elevated baseline with wide transferred packets containing multiple detection events. In addition, the recovery of the elevated baseline can cause noise peak artefacts at the time when the baseline slowly crosses the discriminator threshold.

### Example 4

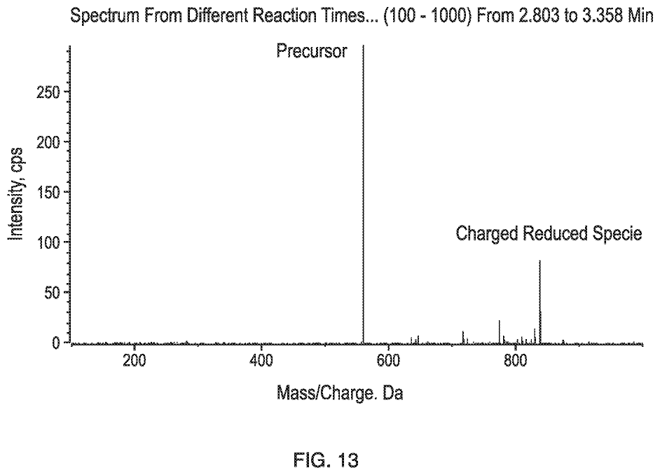

FIG. 13 shows the mass spectrum of protonated Neurotensin precursor ion [M+3H]³⁺ as well as several fragment ions generated via electron capture dissociation of the protonated precursor ion. In addition to the fragment ions, the mass spectrum shows a mass peak corresponding to the charge reduced species [M+2H]²⁺ generated via the following electron capture reaction:

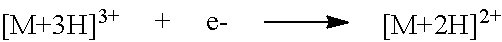

The mass spectrum shows that the signal intensities of the protonated precursor ion and the charge reduced species are significantly greater than those associated with the fragment ions. Further, the mass spectrum shows a relatively large number of fragment ions. As discussed above, both of these characteristics of the mass spectrum leads to certain challenges associated with the data acquisition via application of a single gain factor. Further, as discussed above the present teachings provide a dynamically adjustable gain that can be modified to account for differences in the signal intensities of the mass peaks within a mass spectrum.

As used herein the term “and/or” includes any and all combinations of one or more of the associated listed items and may be abbreviated as “/”. Although some aspects have been described in the context of an apparatus, it is clear that these aspects also represent a description of the corresponding method, where a block or device corresponds to a method step or a feature of a method step. Analogously, aspects described in the context of a method step also represent description of a corresponding block or item or feature of a corresponding apparatus. Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware and/or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

While various embodiments have been illustrated and described in detail in the drawings and foregoing description, such illustration and description are to be considered illustrative or exemplary and not restrictive; embodiments of the present disclosure are not limited to the disclosed embodiments. Other variations to the disclosed embodiments can be understood and effected by those skilled in the art in practicing embodiments of the present disclosure, from a study of the drawings, the disclosure, and the appended claims.

In the claims, the word “comprising” does not exclude other elements or steps, and the indefinite article “a” or “an” does not exclude a plurality. A single processor or other processing unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

Those having ordinary skill in the art will appreciate that various changes can be made to the above embodiments without departing from the scope of the present teachings.

1. A method of performing mass spectrometry, comprising:
using an ion detector associated with a time-of-flight (ToF) mass analyzer to detect ions associated with at least one ToF ion extraction event and generating respective ion detection signals, and
applying an adjustable gain to the ion detection signals thereby generating gain-adjusted ion detection signals, wherein the gain applied to each ion detection signal is selected as one of a baseline gain and a fraction of the baseline gain based on an expected intensity of the ion detection signal.

2. The method of claim 1, wherein said at least one ToF ion extraction event comprises one or more ion detection signals for which the baseline gain is selected and one or more ion detection signals for which the fraction of the baseline gain is selected.

3. The method of claim 1, further comprising digitizing said gain-adjusted ion detection signals so as to generate a plurality of digital gain-adjusted ion detection signals.

4. The method of claim 3, further comprising processing the digital gain-adjusted ion detection signals to correct for variations, if any, in the gain applied to the ion detection signals and constructing a mass spectrum of the detected ions based on the corrected gain-adjusted ion detection signals.

5. The method of claim 1, further comprising performing a survey scan to obtain data indicative of the expected intensities of the ion detection signals.

6. The method of claim 3, wherein the processing of the digital gain-adjusted ion detection signals comprises scaling an intensity of each of said gain-adjusted ion detection signals using a ratio of baseline gain and adjusted gain associated with that signal.

7. The method of claim 1, wherein said mass spectrometer is operated in an MS/MS mode.

8. The method of claim 7, wherein said ions comprise at least one of (1) product ions generated via fragmentation of at least one precursor ion, (2) residual of said at least one precursor ion, and (3) a charged reduced version of said at least one precursor ion.

9. The method of claim 8, wherein said ions comprise a mixture of the product ions and the residual of said at least one precursor ion.

10. The method of claim 7, further comprising applying the fraction of the baseline gain to ion signals associated with any of said (1) residual of said at least one precursor ion and (2) said charge reduced version of said at least one precursor ion.

11. The method of claim 10, wherein said fraction of the baseline gain for application to the ion detection signals associated with any of said residual precursor ion and said charged reduced version of said at least one precursor ion is selected prior to data acquisition.

12. The method of claim 9, wherein a fraction of the residual of said at least one precursor ion in said mixture is in a range of about 1% to about 90%, optionally in range of about 5% to about 80%, optionally in a range of about 10% to about 70%, optionally in a range of about 30% to about 50%, and optionally in a range of about 20% to about 60%.

13. The method of claim 1, wherein at least a portion of the ions received by the ToF mass analyzer was subjected to trapping and subsequent release prior to arrival at the ToF mass analyzer.

14. The method of claim 13, wherein said trapping and subsequent release of the ions results in generation of a temporally discontinuous ion beam for delivery to said ToF mass analyzer, wherein said temporally discontinuous ion beam such that the ToF mass analyzer receives substantially all ions during signal periods and substantially no ions during periods between the signal periods, and wherein optionally said signal periods contain at least 90% of all ions.

15. The method of claim 14, further comprising selecting a dwell time of any of at least 90%, at least 80%, or at least 70%, at least 60%, at least 50%, at least 40%, at least 30%, at least 20%, and at least 10% for the signal periods.

16. The method of claim 1, wherein said step of applying the adjustable gain comprises using any of an amplifier or attenuator to apply the gain to the ion detection signals, and wherein optionally the step of selecting the gain comprises configuring the amplifier to apply any of said baseline gain and said fraction of the baseline gain to the ion detection signals.

17. The method of claim 16, wherein the step of selecting the gain comprises configuring two amplifiers positioned in tandem as a single amplification unit for application of any of said baseline gain and said fraction of the baseline gain to the ion detection signals.

18. The method of claim 17, further comprising configuring one of said two amplifiers to switch from a high gain mode to a low gain mode at a first predefined time during the ion extraction event and the other of said two amplifiers to switch from a low gain mode to a high gain mode during a second predefined time during the ion extraction event so as to cooperatively provide said fraction of the baseline gain during a time interval between said first and said second predefined times.

19. The method of claim 1, wherein the step of applying the adjustable gain comprises configuring two amplifiers positioned in parallel to provide different gains and routing the ion detection signals in parallel data streams to said two amplifiers to generate two sets of amplified ion detection signals at different gains and independently digitizing the two sets of the amplified ion detection signals to generate two sets of digital ion detection signals, and further comprising processing said two sets of the digital ion detection signals to generate a single mass spectrum of the ions.

20. A system for use in a mass spectrometer for acquisition of mass-to-charge data using a time-of-flight (ToF) mass analyzer, comprising:
an ion detector configured to detect ions and generate ion detection signals in response to the detection of ions during each of a plurality of ion extraction events,
at least one gain device operably coupled to the ion detector for applying an adjustable gain to the ion detection signals to generate gain-adjusted ion detection signals, and
a controller in communication with the at least one gain device and configured to send one or more control signals based on an expected intensity of each ion detection signal to the gain device such that the gain device applies one of a baseline gain and a fraction of baseline gain to that ion detection signal, thereby generating a plurality of gain-adjusted ion detection signals.
